(19) United States
(12) Patent Application Publication
(10) Pub. No.: US 2026/0274129 A1
(43) Pub. Date: Sep. 17, 2026

(54) FLEXION-EXTENSION JOINT AND SCREEN BRACKET HAVING THE SAME

(71) Applicant: MODERNSOLID INDUSTRIAL CO., LTD., Taichung City (TW)

(72) Inventor: Chin-Jui HUNG, Taichung City (TW)

(73) Assignee: MODERNSOLID INDUSTRIAL CO., LTD., Taichung City (TW)

(21) Appl. No.: 19/539,921

(22) Filed: Feb. 13, 2026

(30) Foreign Application Priority Data
Mar. 14, 2025 (TW) 114109612

(51) Int. Cl. B60N 2/427; B60N 2/30

(52) U.S. Cl. CPC B60N 2/42709; B60N 2/305

(57) ABSTRACT

A flexion-extension joint includes a connection head unit including a connection seat, a connection block, a one-way rotation member, and two damper seats, and a movement unit. The movement unit includes a movement seat rotatable relative to the connection seat, two end covers respectively engaging the damper seats, and a rotation rod. Each end cover and the respective damper seat have static friction generated therebetween. Each end cover has a first friction surface in contact with a first contact surface of the respective damper seat, and the first friction surface of each end cover and the first contact surface of the respective damper seat have kinetic friction generated therebetween when the movement unit rotates upwards. Resistance generated when the movement unit rotates upwards relative to the connection seat is smaller than resistance generated when the movement unit rotates downwards relative to the connection seat.

### CROSS-REFERENCE TO RELATED APPLICATION

This application claims priority to Taiwanese Invention Patent Application No. 114109612, filed on Mar. 14, 2025, the entire disclosure of which is incorporated by reference herein.

### FIELD

The disclosure relates to a screen bracket, and more particularly to a flexion-extension joint and a screen bracket having the same.

### BACKGROUND

Conventional screen brackets can be used to support a display device, and be positioned at different angles. Some conventional screen brackets even feature triple monitor arm design, allowing the display device mounted thereon to hover above the desk or to be moved to and positioned at the desired position, which is convenient for use.

An adjustment mechanism and a display device support having the same disclosed in Chinese Utility Model Patent No. CN221570038U are adapted to be connected to a liquid crystal display device. The adjustment mechanism includes a U-shaped member, a supporting member, two friction members, two pads, and a fastening member. The U-shaped member has two wings that extend to be parallel to each other. The supporting member is located between the wings. The friction members are respectively located at outer sides of the wings. The pads are clamped between the wings and the friction members. The fastening member passes through the friction members, the pads, the wings, and the supporting member. By means of friction generated between inner surfaces of the wings and two opposite ends of the supporting member, and friction generated between outer surfaces of the wings and the pads, the liquid crystal display device is prevented from tilting downward, and has a positioning effect due to the friction.

However, during use, when lifting the liquid crystal display device mounted on the aforementioned adjustment mechanism, the user has to resist gravity and friction at the same time, which is more laborious and results in a poor user experience.

### SUMMARY

Therefore, an object of the disclosure is to provide a flexion-extension joint that can alleviate at least one of the drawbacks of the prior art.

According to the disclosure, the flexion-extension joint includes a connection head unit, and a movement unit. The connection head unit includes a connection seat, a connection block, a one-way rotation member, and two damper seats. The connection seat has an accommodation hole extending along an axis. The connection block is disposed in the accommodation hole along the axis, and has a circular portion and two extension portions respectively connected to two opposite sides of the circular portion in a left-right direction. The axis extends in the left-right direction. Each of the extension portions has a non-circular cross-section. The one-way rotation member is mounted between the connection seat and the connection block, and is sleeved on the circular portion of the connection block. The damper seats are respectively secured to the extension portions and are adjacent to the one-way rotation member. Each of the damper seats has a first contact surface that surrounds and extends along the axis. The connection head unit is mounted to the movement unit. The movement unit is rotatable relative to the connection seat in a top-bottom direction perpendicular to the left-right direction, and includes a movement seat that is rotatable relative to the connection seat, two end covers that are spaced apart from each other in the left-right direction, that are disposed on the movement seat and that are respectively in frictional contact with the damper seats, and a rotation rod that extends through the end covers, the movement seat and the connection head unit along the axis. Each of the end covers and the respective one of the damper seats have static friction generated therebetween. Each of the end covers has a first friction surface that extends along the axis, and that is in contact with the first contact surface of the respective one of the damper seats, so that the first friction surface of each of the end covers and the first contact surface of the respective one of the damper seats have kinetic friction generated therebetween when the movement unit rotates upwards. Resistance generated when the movement unit rotates upwards relative to the connection seat is smaller than resistance generated when the movement unit rotates downwards relative to the connection seat.

Another object of the disclosure is to provide a screen bracket that can alleviate at least one of the drawbacks of the prior art.

According to the disclosure, the screen bracket includes a connection unit and the abovementioned flexion-extension joint. The connection unit is adapted to be connected to a screen. The movement seat of the flexion-extension joint is secured to the connection unit.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary perspective view illustrating a first embodiment of a flexion-extension joint and a connection unit according to the disclosure being mounted to a screen.

FIG. 2 is a rear view of the first embodiment and the connection unit.

FIG. 3 is a partly exploded perspective view of the first embodiment and the connection unit.

FIG. 4 is another partly exploded perspective view of the first embodiment and the connection unit.

FIG. 5 is a partly exploded perspective view of the first embodiment.

FIG. 6 is an exploded perspective view of a connection head unit of the first embodiment.

FIG. 7 is another exploded perspective view of the connection head unit of the first embodiment.

FIG. 8 is a sectional view taken alone line VIII-VIII in FIG. 2.

FIG. 9 is a sectional view taken alone line IX-IX in FIG. 2.

FIG. 10 is a schematic view illustrating a one-way rotation member of the connection head unit being in a locked state where an inner ring of the one-way rotation member cannot rotate relative to an outer ring of the one-way rotation member.

FIG. 11 is a schematic view illustrating the one-way rotation member being in a rotatable state where the inner ring can rotate relative to the outer ring.

FIG. 12 is a sectional view illustrating a movement unit of the first embodiment rotating downwards.

FIG. 13 is a sectional view illustrating the movement unit rotating upwards.

FIGS. 14a and 14b are schematic views illustrating a process of the screen being moved downwards.

FIGS. 15a and 15b are schematic views illustrating a process of the screen being moved upwards.

FIG. 16 is a partly exploded perspective view of a second embodiment of the flexion-extension joint.

FIG. 17 is a sectional view of the second embodiment and the connection unit.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

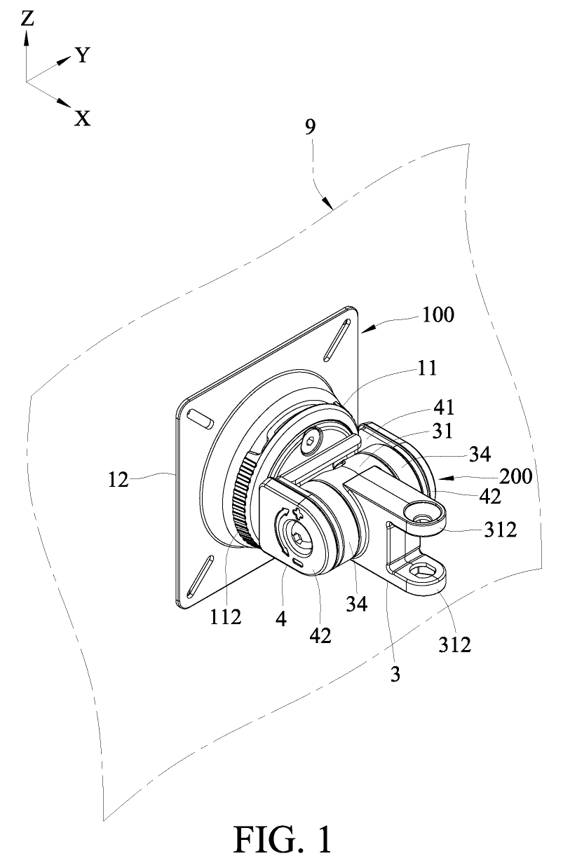

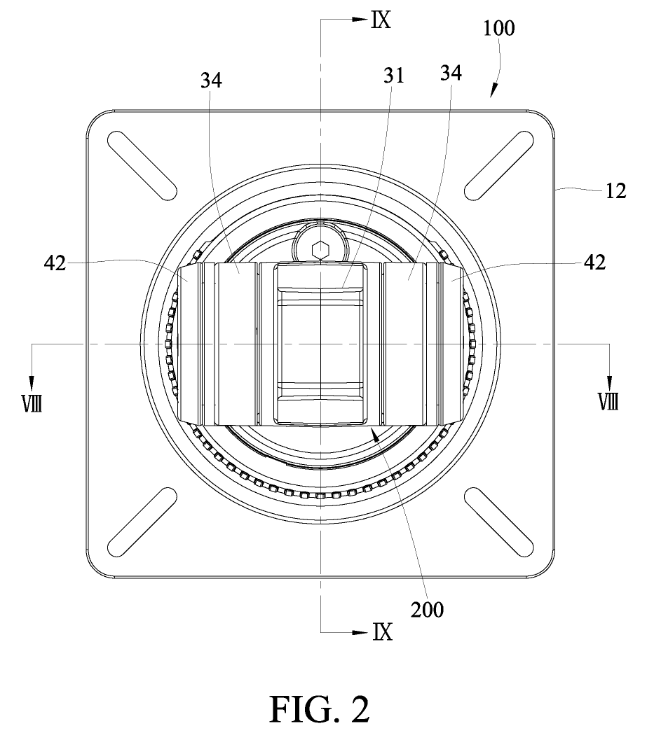

Referring to FIGS. 1-3, a first embodiment of a flexion-extension joint 200 and a connection unit 100 of a screen bracket according to the disclosure is adapted to be mounted to a screen 9. The screen bracket includes the connection unit 100 adapted to be connected to the screen 9, and the flexion-extension joint 200. The flexion-extension joint 200 is adapted to be mounted to a cantilever (not shown), so that the screen 9 is rotatable and movable in any direction.

Referring to FIGS. 1, 3 and 4, the connection unit 100 includes a connection seat 11, and a secure seat 12 that is adapted to be connected to the screen 9 and that is detachably mounted to the connection seat 11. The flexion-extension joint 200 is mounted to the connection seat 11.

The connection seat 11 includes a connection disc 111, and a rotation disc 112 that is rotatable relative to the connection disc 111. The flexion-extension joint 200 is mounted to the connection disc 111. The connection disc 111 has an installation groove 113, a center hole 114 and multiple secure holes 115. The installation groove 113 has an open end 116. The center hole 114 extends along a first axis (L) that extends in a front-rear direction (X). The secure holes 115 are disposed around the center hole 114. The rotation disc 112 has a circular shape and is rotatable about the first axis (L) relative to the connection disc 111. The rotation disc 112 has a notch 117 that is able to be registered with the open end 116 of the installation groove 113.

The secure seat 12 has multiple fastening slots 121 and an engagement piece 122. The fastening slots 121 are located on four corners of the secure seat 12, and each of the fastening slots 121 inclines towards the first axis (L). The screen 9 may be secured to the secure seat 12 through the fastening slots 121. The engagement piece 122 is inserted into the installation groove 113 through the notch 117 and the open end 116 that are registered with each other, so that the secure seat 12 is mounted to the connection seat 11. After insertion of the engagement piece 122 into the installation groove 113, the rotation disc 112 is rotated to make the notch 117 away from the open end 116 until the open end 116 is closed by the rotation disc 112, so that the secure seat 12 is secured to the connection seat 11.

The flexion-extension joint 200 is mounted to the connection seat 11 of the connection unit 100 along the first axis (L), and includes a connection head unit 3 and a movement unit 4. The connection head unit 3 is mounted to the movement unit 4.

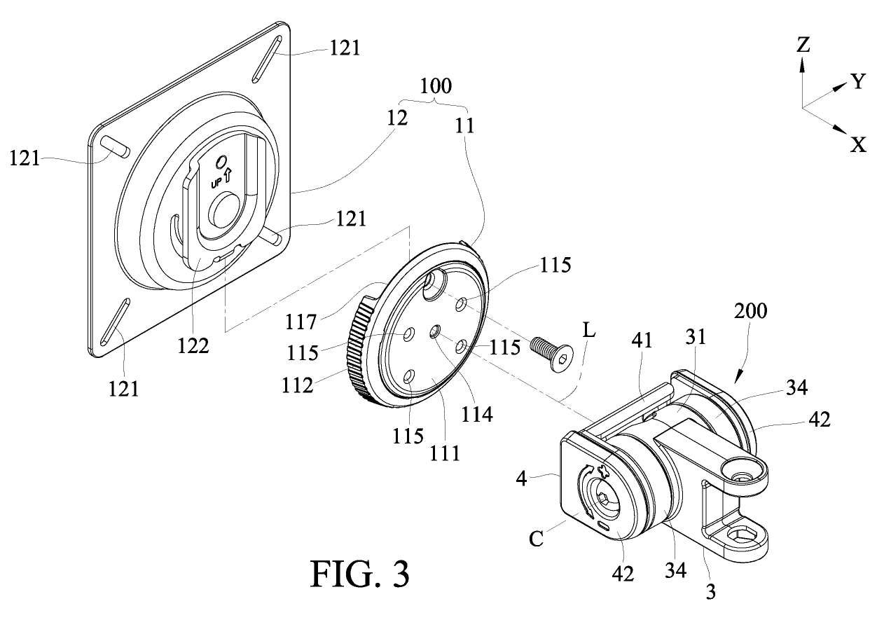

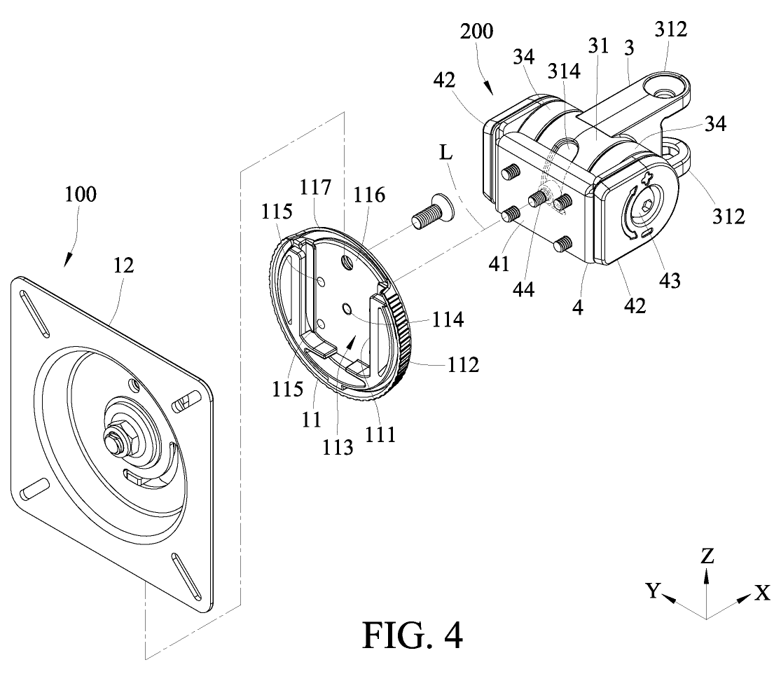

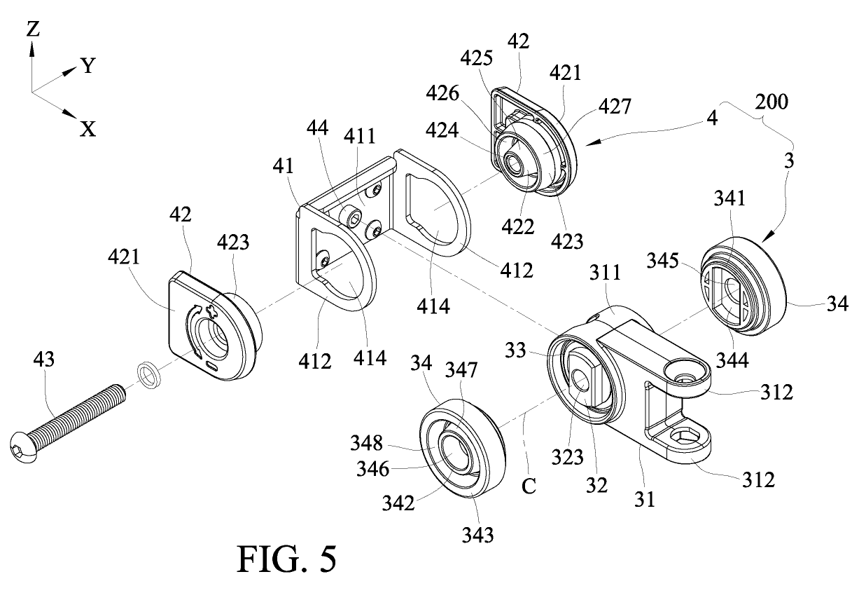

Referring to FIGS. 4-6, the connection head unit 3 is adapted to be mounted to the cantilever (not shown), and includes a connection seat 31, a connection block 32, a one-way rotation member 33 and two damper seats 34. The connection seat 31 has a barrel body 311 that has a shape of a tube, and two extension arms 312 that extend from the barrel body 311. The barrel body 311 has an accommodation hole 313 and a limitation groove 314. The accommodation hole 313 extends along a second axis (C) that extends in a left-right direction (Y) and that is substantially perpendicular to the first axis (L) (see FIG. 3). The left-right direction (Y) is perpendicular to the front-rear direction (X).

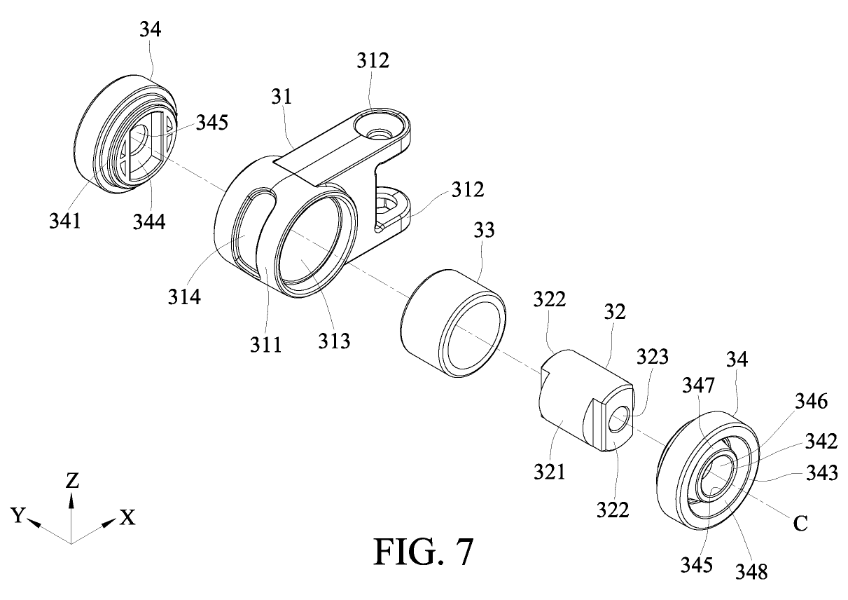

Referring to FIGS. 4 and 7, the limitation groove 314 is formed in an outer surface of the barrel body 311, is arcuate about the second axis (C), and has two opposite ends in a top-bottom direction (Z) perpendicular to the left-right direction (Y) and the front-rear direction (X). The extension arms 312 are opposite to each other in the top-bottom direction (Z) and are adapted to be fastened to the cantilever.

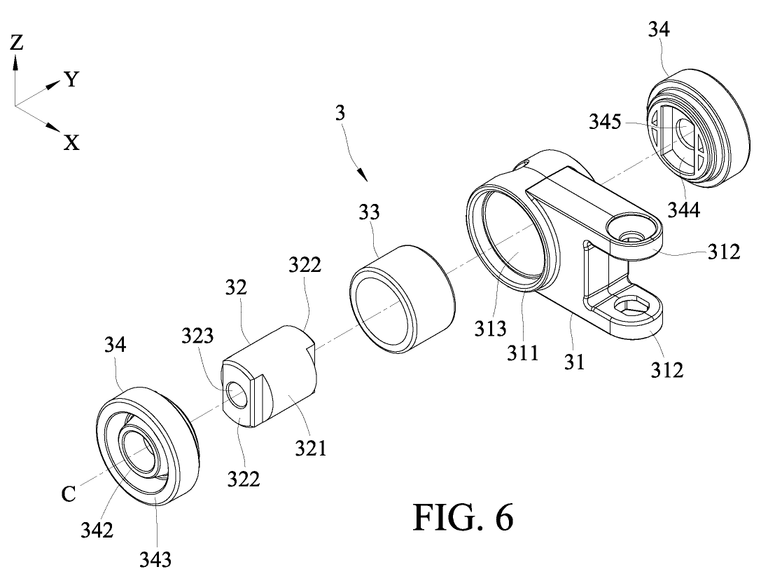

Referring to FIGS. 6-8, the connection block 32 is disposed in the accommodation hole 313 along the second axis (C), and has a circular portion 321, and two extension portions 322 respectively connected to two opposite sides of the circular portion 321 in the left-right direction (Y). The connection block 32 further has an axle hole 323 that extends along the second axis (C). Each of the extension portions 322 has a non-circular cross-section.

Referring to FIGS. 7-9, the one-way rotation member 33 is mounted between the connection seat 31 and the connection block 32, and is sleeved on the circular portion 321 of the connection block 32. In some examples, the one-way rotation member 33 may be a sprag clutch, an overrunning clutch or the like. An outer ring of the one-way rotation member 33 is secured to the connection seat 31 and an inner ring of the one-way rotation member 33 is secured to the connection block 32. When the inner ring of the one-way rotation member 33 is rotatable relative to the outer ring of the one-way rotation member 33, the connection block 32 is rotatable relative to the connection seat 31. When the inner ring of the one-way rotation member 33 is non-rotatable relative to the outer ring of the one-way rotation member 33, the connection block 32 and the connection seat 31 form rigid connection therebetween and may transmit torque, which has a one-way transmission effect.

Referring to FIGS. 6-8, the damper seats 34 are respectively secured to the extension portions 322 of the connection block 32, and are adjacent to the one-way rotation member 33 in the left-right direction (Y). Each of the damper seats 34 has a damper seat body 341, a damper inner ring 342 that is disposed on the damper seat body 341 and that extends along the axis (C), and a damper outer ring 343 that is disposed on the damper seat body 341 and that surrounds and is spaced apart from the damper inner ring 342. The damper seat body 341 has an accommodation groove 344 that is opposite to the damper inner ring 342 and the damper outer ring 343 in the left-right direction (Y) and that is non-circular. Each of the extension portions 322 of the connection block 32 engages and is accommodated in the accommodation groove 344 of the respective damper seat 34, so that the damper seats 34 and the connection block 32 are co-rotatable. Each of the damper seats 34 further has a damper hole 345 that extends along the axis (C) and that is in spatial communication with the accommodation groove 344. The damper inner ring 342 of each of the damper seats 34 has a first contact surface 346 that surrounds and extends along the axis (C) and that is on an inner side of the damper inner ring 342, and a second contact surface 347 that surrounds the first contact surface 346. In this embodiment, for each of the damper seats 34, the damper inner ring 342 is tapered, the first contact surface 346 is a frustoconical surface that tapers towards another damper seat 34, and the second contact surface 347 is a frustoconical surface that tapers away from the another damper seat 34. The damper outer ring 343 of each of the damper seats 34 has a third contact surface 348 that surrounds the second contact surface 347, and the third contact surface 348 of each of the damper seats 34 is a frustoconical surface that tapers towards the another damper seat 34.

Referring to FIGS. 4, 5 and 8, the movement unit 4 is secured to the connection unit 100. The movement unit 4 is rotatable relative to the connection seat 31 in the top-bottom direction (Z), so as to adjust an angle of the movement unit 4 relative to the connection seat 31. The movement unit 4 includes a movement seat 41, two end covers 42, a rotation rod 43 and a limitation rod 44.

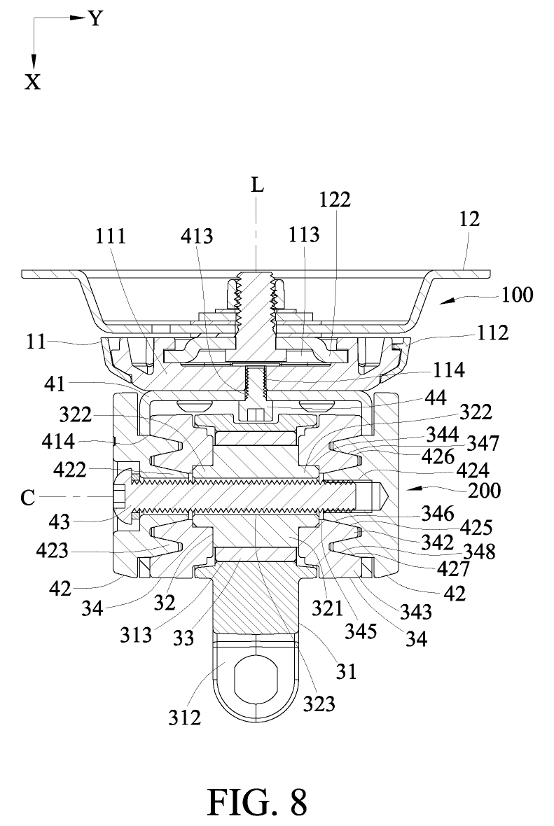

The movement seat 41 is secured to the connection seat 11; specifically, the movement seat 41 is connected to the secure holes 115 of the connection disc 111 by screws. The movement seat 41 is rotatable relative to the connection seat 31. The movement seat 41 is substantially U-shaped, and has a base wall 411, and two side walls 412 that respectively extend from two opposite sides of the base wall 411. The base wall 411 has an engagement hole 413 that extends in the front-rear direction (X) (see FIG. 8). The side walls 412 respectively abut against the damper seats 34, and each of the side walls 412 has an installation hole 414.

The end covers 42 are spaced apart from each other in the left-right direction (Y), are disposed on the movement seat 41, and respectively in frictional contact with the damper seats 34. The end covers 42 are respectively mounted to the side walls 412. Each of the end covers 42 has a main wall 421 that is shaped to correspond to the respective side wall 412, an inner surrounding wall 422 that surrounds and extends along the axis (C) from the main wall 421 through the installation hole 414 of the respective side wall 412, and an outer surrounding wall 423 that surrounds and is spaced apart from the inner surrounding wall 422 and that extends through the installation hole 414 of the respective side wall 412. Each of the end covers 42 further has an opening 424 that extends along the axis (C). For each of the end covers 42, the inner surrounding wall 422 has a first friction surface 425 that surrounds and extends along the axis (C), that is on an outer side of the inner surrounding wall 422, and that is in contact with the first contact surface 346 of the respective damper seat 34, and the outer surrounding wall 423 has a second friction surface 426 that surrounds and extends along the axis (C), and a third friction surface 427 that surrounds the second friction surface 426. In this embodiment, the inner surrounding wall 422 and the outer surrounding wall 423 of each of the end covers 42 are tapered. The first friction surface 425, the second friction surface 426 and the third friction surface 427 of each of the end covers 42 are frustoconical surfaces.

Friction is generated between the end covers 42 and the damper seats 34. Specifically, for each of the end covers 42, since the first friction surface 425 and the first contact surface 346 of the respective damper seat 34 have static friction generated therebetween, the second friction surface 426 and the second contact surface 347 of the respective damper seat 34 are in contact with each other and have static friction generated therebetween, and the third friction surface 427 and the third contact surface 348 of the respective damper seat 34 are in contact with each other and have static friction generated therebetween, the screen 9 may be positioned at a desired angle without sagging. It should be noted that by virtue of the double ring design of each of the end covers 42 and the damper seats 34, the contact area between the end covers 42 and the damper seats 34 is increased, and thus more friction is generated therebetween compared to the prior art, so that the screen 9 with greater weight may be supported.

The rotation rod 43 extends through the end covers 42, the movement seat 41 and the connection head unit 3 along the axis (C). Specifically, the rotation rod 43 extends through the openings 424 of the end covers 42 and the axle hole 323 of the connection block 32, and one end of the rotation rod 43 is threadedly connected to one of the end covers 42. The rotation rod 43 is substantially not in contact with the connection block 32, and the other end of the rotation rod 43 and the other one of the end covers 42 (that is adjacent the other end of the rotation rod 43) have spring washers (see FIG. 8) disposed therebetween.

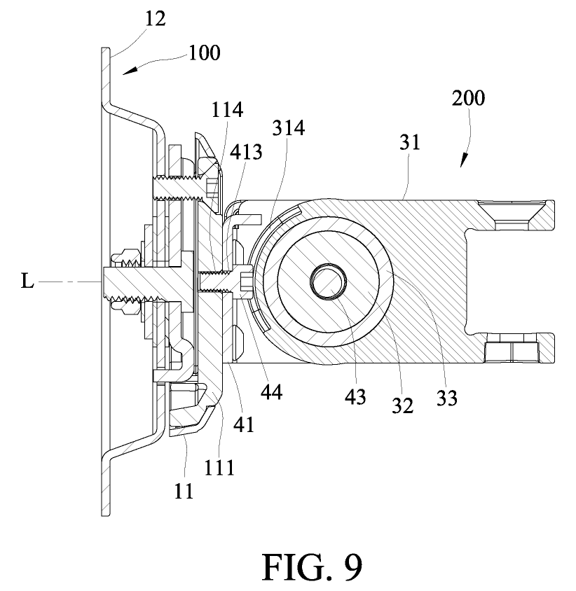

Referring to FIGS. 4 and 9, the limitation rod 44 is disposed in (specifically, threadedly connected to) the engagement hole 413 of the movement unit 41 and the center hole 114 of the connection disc 111 and partially extends into (specifically, is slidably disposed in) the limitation groove 314. Specifically, the limitation rod 44 is slidable between the two opposite ends of the limitation groove 314, to thereby limit a range of movement of the movement unit 4 relative to the connection seat 31, and thus the screen 9 will not be overly moved upwards or downwards.

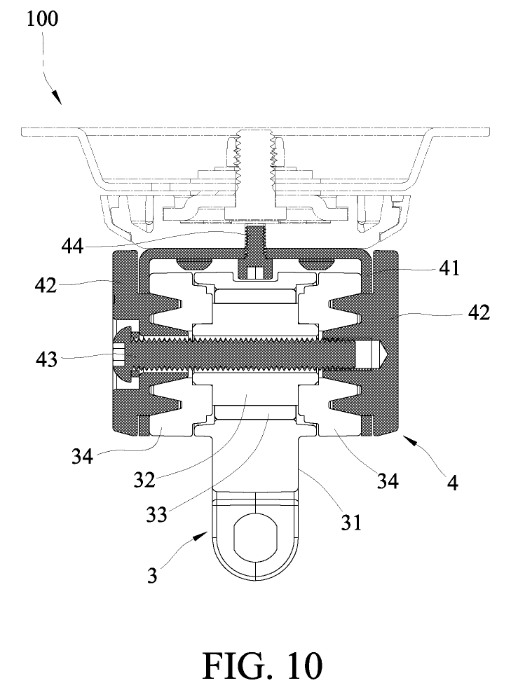

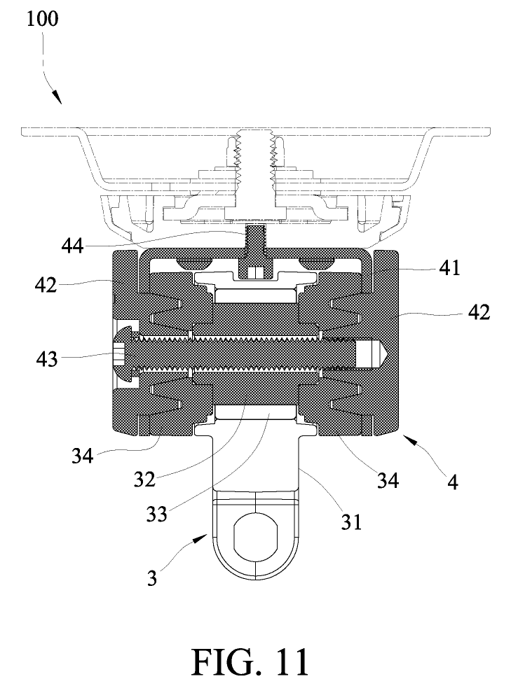

Referring to FIGS. 10 and 11, torque transmission during the movement of the movement unit 4 relative to the connection seat 31 is illustrated. For convenience of description, the connection unit 100 is drawn with dashed-dotted lines, and the components that move are filled with gray, and the components that do not move are not filled with gray.

Referring to FIG. 10, the one-way rotation member 33 is in a locked state where the inner ring of the one-way rotation member 33 cannot rotate relative to the outer ring of the one-way rotation member 33. The connection block 32 and the connection seat 31 form rigid connection therebetween through the one-way rotation member 33, the connection block 32 is non-rotatable relative to the connection seat 31, and the damper seats 34 are blocked by the connection block 32 from rotating. During the torque transmission, the movement seat 41, the end covers 42, the rotation rod 43 and the limitation rod 44 are rotated. Kinetic friction between the end covers 42 and the damper seats 34 is generated when the movement unit 4 rotates to resist the torque. Specifically, the first friction surface 425 of each end cover 42 and the first contact surface 346 of the respective damper seat 34 have kinetic friction generated therebetween when the movement unit 4 is rotated downwards by an external force.

Referring to FIG. 11, the one-way rotation member 33 is in a rotatable state where the inner ring of the one-way rotation member 33 is rotatable relative to the outer ring of the one-way rotation member 33. The connection block 32 is rotatable relative to the connection seat 31. During the torque transmission, the movement seat 41, the end covers 42, the rotation rod 43, the limitation rod 44, the damper seats 34 and the connection block 32 are rotated. At this time, the end covers 42 and the damper seats 34 rotate together in the same direction, and thus only static friction is generated therebetween.

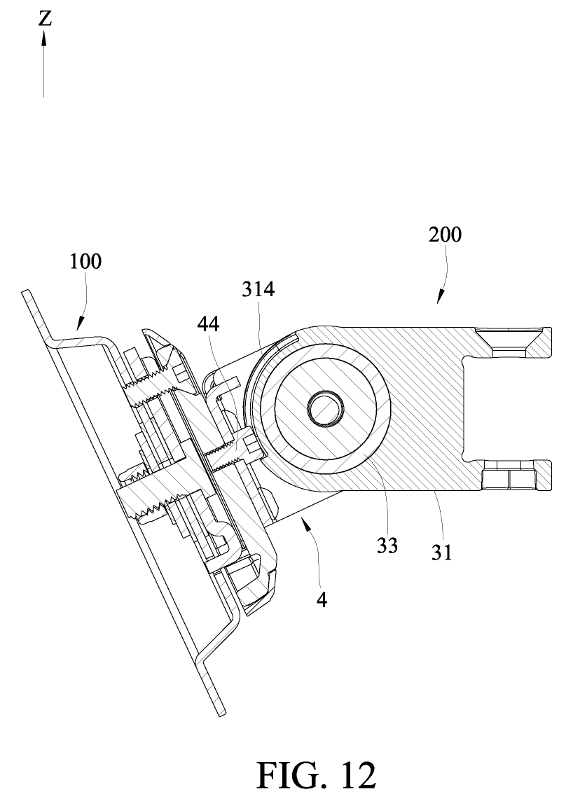

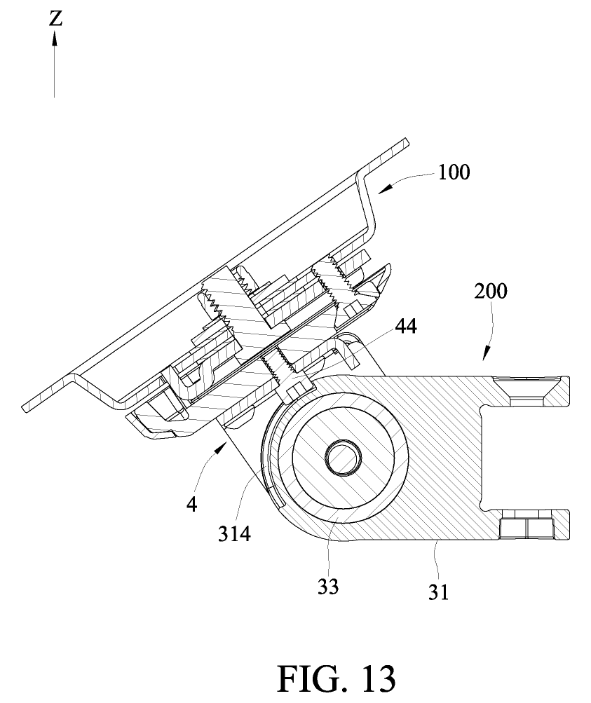

Referring to FIGS. 12 and 13, when being rotated, the connection unit 100 drives the movement unit 4 to rotate upwards and downwards relative to the connection seat 31, so as to adjust the angle of the screen 9.

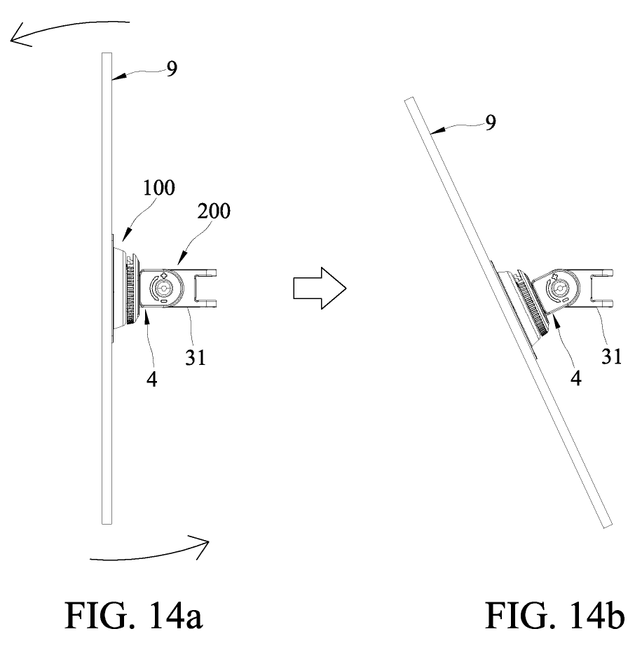

Referring to FIGS. 8, 12, 14a and 14b, when the screen 9 is moved downwards, since the inner ring of the one-way rotation member 33 cannot rotate relative to the outer ring of the one-way rotation member 33, the user has to overcome the maximum static friction between the end covers 42 and the damper seats 34 to rotate the movement unit 4 downwards relative to the connection seat 31. Thus, a force resulting from a downward external force exerted on the screen 9 has to be greater than the maximum static friction between the end covers 42 and the damper seats 34 minus a force resulting from the weight of the screen. During rotation of the movement unit 4, when the limitation rod 44 moves to and abuts against one of the ends of the limitation groove 314 (i.e., the bottom end of the limitation groove 314), the movement unit 4 cannot rotate downwards anymore.

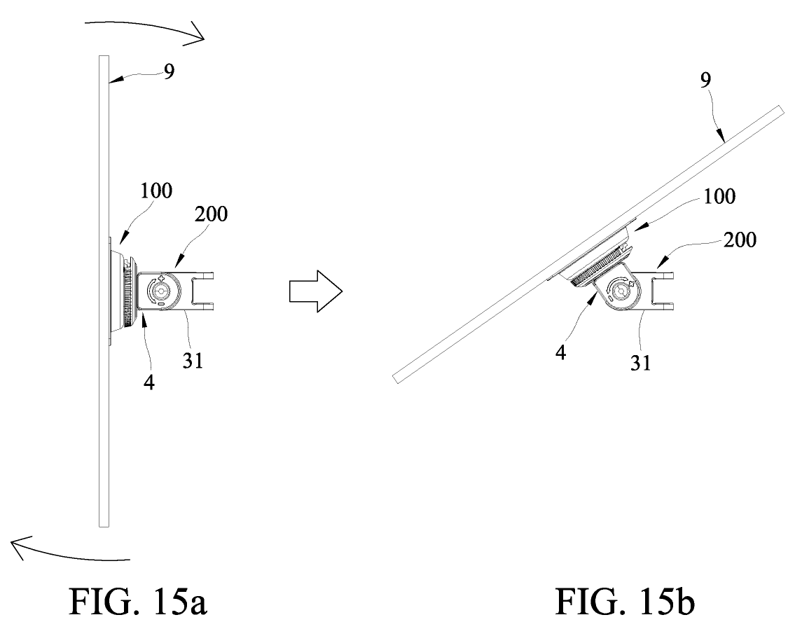

Referring to FIGS. 8, 13, 15a and 15b, when the screen 9 is moved upwards, since the inner ring of the one-way rotation member 33 is rotatable relative to the outer ring of the one-way rotation member 33, the connection block 32 is rotatable relative to the connection seat 31, and the end covers 42 and the damper seats 34 rotate together in the same direction so that only static friction is generated therebetween. Thus, an upward force exerted on the screen 9 only has to be greater than the weight of the screen. Resistance generated when the screen 9 is moved upwards (i.e., when the movement unit 4 rotates upwards relative to the connection seat 31) is smaller than resistance generated when the screen 9 is moved downwards (i.e., when the movement unit 4 rotates downwards relative to the connection seat 31), which is convenience for use.

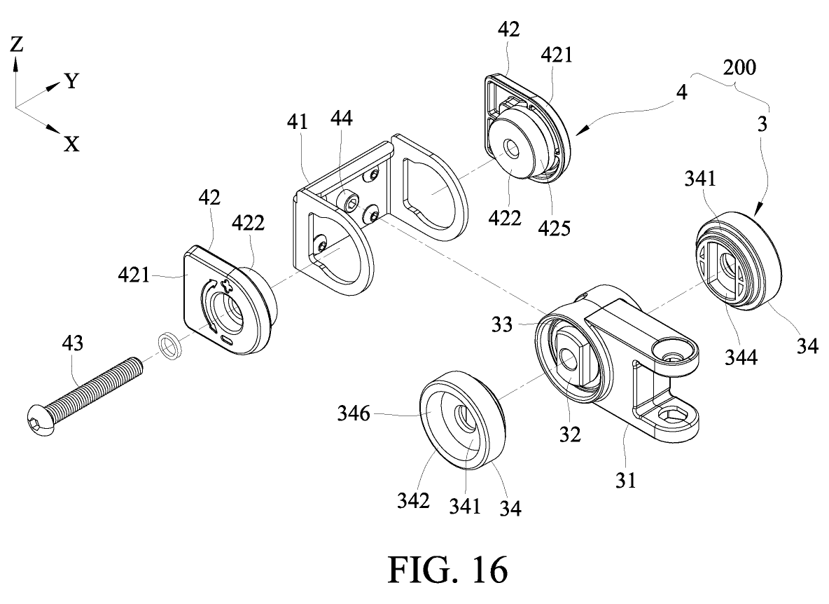

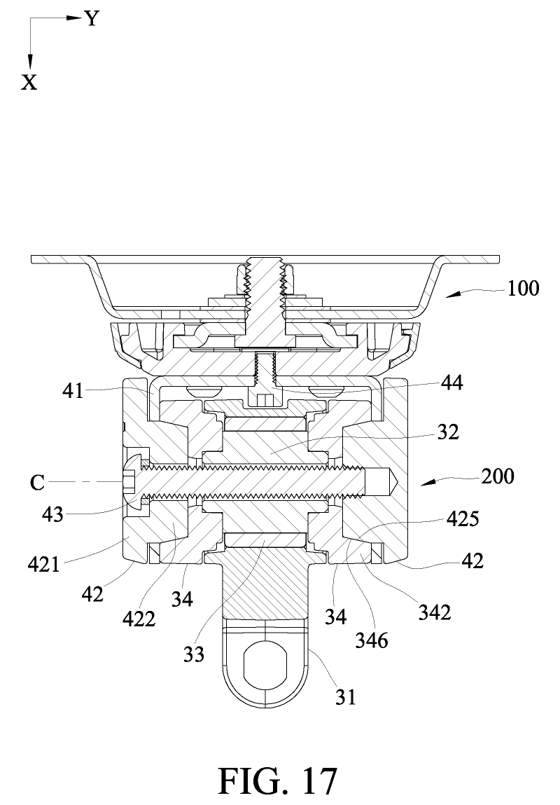

Referring to FIGS. 16 and 17, a second embodiment of the flexion-extension joint according to the disclosure is illustrated, and differences between the first and second embodiments are as follows.

Each of the damper seats 34 has single ring design, and has the damper seat body 341, and the damper inner ring 342 that extends along the axis (C) and that is disposed on the damper seat body 341. The damper seat body 341 of each of the damper seats 34 has the accommodation groove 344 that is opposite to the damper inner ring 342 in the left-right direction (Y). An outer surrounding surface of the damper inner ring 342 of each of the damper seats 34 has a cylindrical shape, and the damper inner ring 342 of each of the damper seats 34 has the first contact surface 346 on the inner side thereof. The first contact surface 346 of each of the damper seats 34 is a frustoconical surface.

Each of the end covers 42 has single ring design, and has the main wall 421, and the inner surrounding wall 422 that extends along the axis (C) from the main wall 421. The inner surrounding wall 422 of each of the end covers 42 is tapered, and has the first friction surface 425 that is on an outer side of the inner surrounding wall 422, that is a frustoconical surface, and that is in contact with the first contact surface 346 of the respective damper seat 34. In the second embodiment, the end covers 42 and the damper seats 34 may generate friction therebetween.

To sum up, since the one-way rotation member 33 is disposed between the connection seat 31 and the connection block 32, and only rotates in a single direction, movement of the connection seat 31 and the connection block 32 is affected thereby. When the screen 9 is moved upwards, the end covers 42 and the damper seats 34 rotate together in the same direction so that only static friction is generated therebetween, and thus resistance generated when the screen 9 is moved upwards (i.e., when the movement unit 4 rotates upwards relative to the connection seat 31) is smaller than resistance generated when the screen 9 is moved downwards (i.e., when the movement unit 4 rotates downwards relative to the connection seat 31), which is labor-saving and has a better operation feeling. Furthermore, damage caused by friction generated between the end covers 42 and the damper seats 34 is decreased due to the configuration of the one-way rotation member 33, which extends the service life of the screen bracket, thus achieving the object of the disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A flexion-extension joint for a screen bracket, comprising:
a connection head unit including
a connection seat that has an accommodation hole extending along an axis,
a connection block that is disposed in said accommodation hole along the axis, and that has a circular portion and two extension portions respectively connected to two opposite sides of said circular portion in a left-right direction, the axis extending in the left-right direction, each of said extension portions having a non-circular cross-section,
a one-way rotation member that is mounted between said connection seat and said connection block, and that is sleeved on said circular portion of said connection block, and
two damper seats that are respectively secured to said extension portions and that are adjacent to said one-way rotation member, each of said damper seats having a first contact surface that surrounds and extends along the axis; and
a movement unit, said connection head unit being mounted to said movement unit, said movement unit being rotatable relative to said connection seat in a top-bottom direction perpendicular to the left-right direction, and including a movement seat that is rotatable relative to said connection seat, two end covers that are spaced apart from each other in the left-right direction, that are disposed on said movement seat and that are respectively in frictional contact with said damper seats, and a rotation rod that extends through said end covers, said movement seat and said connection head unit along the axis, each of said end covers and said respective one of said damper seats having static friction generated therebetween;
wherein each of said end covers has a first friction surface that extends along the axis, and that is in contact with said first contact surface of said respective one of said damper seats, so that said first friction surface of each of said end covers and said first contact surface of said respective one of said damper seats have kinetic friction generated therebetween when said movement unit rotates upwards; and
wherein resistance generated when said movement unit rotates upwards relative to said connection seat is smaller than resistance generated when said movement unit rotates downwards relative to said connection seat.

2. The flexion-extension joint as claimed in claim 1, wherein:
each of said end covers has an inner surrounding wall that surrounds and extends along the axis, and an outer surrounding wall that surrounds and is spaced apart from said inner surrounding wall;
for each of said end covers, said inner surrounding wall has said first friction surface, and said outer surrounding wall has a second friction surface that surrounds and extends along the axis and a third friction surface that surrounds said second friction surface;
each of said damper seats has a damper inner ring that surrounds and extends along the axis and a damper outer ring that surrounds and is spaced apart from said damper inner ring, said damper inner ring of each of said damper seats having said first contact surface, and a second contact surface that surrounds said first contact surface, said damper outer ring of each of said damper seats having a third contact surface that surrounds said second contact surface; and
said second friction surface of each of said end covers and said second contact surface of said respective one of said damper seats have friction generated therebetween, and said third friction surface of each of said end covers and said third contact surface of said respective one of said damper seats have friction generated therebetween.

3. The flexion-extension joint as claimed in claim 2, wherein said inner surrounding wall and said outer surrounding wall of each of said end covers and said damper inner ring of each of said damper seats are tapered.

4. The flexion-extension joint as claimed in claim 3, wherein for each of said damper seats, said first contact surface is a frustoconical surface that tapers towards another one of said damper seats, said second contact surface is a frustoconical surface that tapers away from said another one of said damper seats, and said third contact surface is a frustoconical surface that tapers towards said another one of said damper seats.

5. The flexion-extension joint as claimed in claim 1, wherein said first friction surface of each of said end covers and said first contact surface of each of said damper seats each are frustoconical surfaces.

6. The flexion-extension joint as claimed in claim 5, wherein:
each of said damper seats has a damper inner ring that extends along the axis and that has said first contact surface on an inner side thereof, an outer surrounding surface of said damper inner ring of each of said damper seats having a cylindrical shape; and
each of said end covers has an inner surrounding wall that surrounds and extends along the axis and that has said first friction surface on an outer side thereof.

7. The flexion-extension joint as claimed in claim 1, wherein said movement unit further includes a limitation rod that is disposed in said movement seat, said connection seat further having a limitation groove that has two opposite ends in the top-bottom direction, said limitation rod being slidably disposed in said limitation groove.

8. The flexion-extension joint as claimed in claim 7, wherein said connection seat has a barrel body that has said accommodation hole, and two extension arms that extend from said barrel body, said limitation groove being formed in an outer surface of said barrel body, and being arcuate about the axis.

9. A screen bracket adapted for a screen to be mounted thereon, comprising:
a connection unit adapted to be connected to the screen; and
a flexion-extension joint as claimed in claim 1, said movement seat of said flexion-extension joint being secured to said connection unit.

10. The screen bracket as claimed in claim 9, wherein said connection unit includes a connection seat, and a secure seat that is adapted to be connected to the screen and that is detachably mounted to said connection seat, said flexion-extension joint being mounted to said connection seat.

11. The screen bracket as claimed in claim 10, wherein said connection seat includes a connection disc and a rotation disc that is rotatable relative to said connection disc, said flexion-extension joint being mounted to said connection disc.

12. The screen bracket as claimed in claim 11, wherein said connection disc has an installation groove, a center hole and multiple secure holes, said installation groove has an open end, said center hole extending along another axis that extends in a front-rear direction perpendicular to the left-right direction and the top-bottom direction, said secure holes being disposed around said center hole, said rotation disc having a circular shape and being rotatable about the another axis relative to said connection disc, said rotation disc having a notch that is operable for being registered with said open end of said installation groove.

13. The screen bracket as claimed in claim 12, wherein said secure seat has an engagement piece that is inserted into said installation groove through said notch and said open end that are registered with each other, and after insertion of said engagement piece into said installation groove, said rotation disc is rotated to make said notch away from said open end until said open end is closed by said rotation disc.
